(19) United States
(12) Patent Application Publication
(10) Pub. No.: US 2024/0097230 A1
(43) Pub. Date: Mar. 21, 2024

(54) Battery Device for a Motor Vehicle, and Motor Vehicle Having a Battery Device

(71) Applicant: Bayerische Motoren Werke Aktiengesellschaft, Muenchen (DE)

(72) Inventors: Savo ASANIN, Muenchen (DE); Nicolas FLAHAUT, Muenchen (DE); Philip GUERRERO, Muenchen (DE); Michael HUBER, Muenchen (DE); Tuncay IDIKURT, Muenchen (DE); Qi LI, Muenchen (DE); Alexander RHEINFELD, Muenchen (DE); Robin RUECKER, Schaeftlarn (DE); Aron VARGA, Muenchen (DE); Tyron VIGODSKI, Muenchen (DE); Linda WENZEL, Muenchen (DE)

(21) Appl. No.: 18/038,798

(22) PCT Filed: Jan. 24, 2022
(86) PCT No.: PCT/EP2022/051470

§ 371 Date: May 25, 2023

(30) Foreign Application Priority Data
Feb. 1, 2021 (DE) 10 2021 102 182.0

(51) Int. Cl. H01M 10/613; H01M 10/625; H01M 10/653

(52) U.S. Cl. CPC H01M 10/613; H01M 10/625; H01M 10/653; H01M 50/204

(57) ABSTRACT

The invention relates to a battery device (10) for a motor vehicle, having a plurality of battery cells (12) which are accommodated in a housing and rest at least against a heat-conducting potting compound (20) or a heat-conducting pad, which potting compound or pad rests against at least one structural component (22) of the battery device (10), as a result of which heat (14) can be dissipated from the battery cells (12) to the structural component (22) via the heat-conducting potting compound (20) or the heat-conducting pad.

### BACKGROUND AND SUMMARY OF THE INVENTION

The invention relates to a battery device for a motor vehicle and to a motor vehicle having a battery device.

In the event of a defect of a battery cell in a battery device, particularly in a high-voltage storage unit, this battery cell may run out of control, which is also referred to as so-called thermal runaway. This runaway of the battery cell may lead to enormous heating, in particular beyond 1000 degrees Celsius in the affected battery cell. In a battery module in which a plurality of battery cells are arranged in succession, the heat may propagate from the affected battery cell into neighboring cells and likewise cause these neighboring cells to run away. A chain reaction may therefore occur, in which a cell defect of an individual battery cell can lead to propagation of a plurality of battery cells, or the entire high-voltage storage unit.

A lithium ion battery with thermal runaway protection is known from WO 2015/179625 A1. For this purpose, a cooling mechanism may be implemented, by way of which energy is actively removed from an affected region of the battery and transported to another region, usually outside the battery. Provision of insulation between battery cells of the lithium ion battery is furthermore described. In addition, phase-change material is mentioned as a further option for runaway protection.

Furthermore, U.S. Pat. No. 8,541,126 B2 discloses a battery pack which comprises one or more thermal barrier elements, the thermal barrier elements dividing cells inside the battery pack into groups of cells. These thermal barrier elements that separate the cells into groups prevent a thermal runaway initiated in one group of cells from propagating to cells in a neighboring group of cells.

It is an object of the invention to provide a solution by way of which a chain reaction of the respective runaway of neighboring battery cells of a battery device can be avoided or at least controlled.

This object is achieved according to the claimed invention.

The invention relates to a battery device for a motor vehicle, in particular a high-voltage storage unit. The battery device comprises a plurality of battery cells contained in a housing, which rest at least on a thermally conductive potting compound or a thermally conductive pad. This means that the battery cells are joined in surface contact to the at least one thermally conductive potting compound and/or the at least one thermally conductive pad. The at least one thermally conductive potting compound, or the at least one thermally conductive pad, has a particularly high thermal conduction coefficient so that heat can be absorbed particularly well and especially particularly rapidly from the respectively resting battery by way of the at least one thermally conductive potting compound or by way of the at least one thermally conductive pad, so that the resting battery cells can be cooled particularly well through the at least one thermally conductive potting compound or through the at least one thermally conductive pad. The thermally conductive potting compound, or the thermally conductive pad, in turn rests on at least one structural component of the battery device so that heat can be dissipated from the battery cells to the structural component through the thermally conductive potting compound or the thermally conductive pad. In the event of a runaway of one of the battery cells, a great deal of heat can therefore be dissipated particularly rapidly to the at least one structural component through the thermally conductive potting compound, or through the thermally conductive pad, so that the runaway battery cell can be cooled particularly well. Furthermore, transfer of heat from the runaway battery cell to battery cells neighboring the runaway battery cell can be restricted by the particularly good cooling of the runaway battery cell. In this way, the risk of a runaway of the battery cells neighboring the runaway battery cell and therefore a chain reaction can be kept particularly low.

According to another configuration of the invention, the at least one structural component is the housing or a module frame of the battery device. In this case, the housing and/or the module frame may, for example, at least in regions be formed from aluminum so that the heat received through the at least one thermally conductive potting compound and/or the at least one thermally conductive pad can be transported away particularly rapidly from the runaway battery cell and in particular from further battery cells of the battery device through the housing or the module frame. The at least one structural component may therefore on the one hand fulfill stabilization of the effect of the battery device and on the other hand be used for thermal transport away from a runaway battery cell of the battery device.

According to another configuration of the invention, all battery cells of the battery device rest via the thermally conductive potting compound or the thermally conductive pad on at least one structural component of the battery device. In this way, it is possible to ensure that heat transport from the runaway battery cell through the at least one thermally conductive potting compound, or the at least one thermally conductive pad, to the at least one structural component of the battery device is made possible irrespective of which of the battery cells of the battery device is running away. In other words, each of the battery cells of the battery device is in direct surface contact with at least one thermally conductive potting compound, or at least one thermally conductive pad, so that heat can be dissipated from the respective battery cell through the at least one thermally conductive potting compound, or the at least one thermally conductive pad, to the at least one structural component resting on the thermally conductive potting compound or on the thermally conductive pad.

According to another configuration of the invention, the respective lowermost battery cells of the battery device rest via a thermally conductive element on a cooling device different than the structural component. In particular, the thermally conductive element may be provided by a further thermally conductive potting compound or a further thermally conductive pad. The thermally conductive element allows particularly good heat transfer from the lowermost battery cells of the battery device to the cooling device, so that the battery cells of the battery device can be cooled particularly well by way of the cooling device. The cooling device may, for example, be a cooling plate. By way of the cooling device, heat may be transported away from the battery cells of the battery device, in particular during normal operation of the battery device. In this way, compliance with an operating temperature range in the battery cells of the battery device may be ensured.

According to another configuration of the invention, each of the battery cells is thermally insulated from at least one further battery cell by way of an insulation element. In this case, with a stacked arrangement of a plurality of battery cells, respective battery cells arranged inside the stack may be thermally insulated by way of respective insulation elements from respective neighboring battery cells, in particular from two further battery cells arranged at opposite sides of the respective inner battery cell. The insulation elements are in particular a so-called heat shield. Each insulation element is therefore arranged between two neighboring battery cells and is configured to thermally insulate the neighboring battery cells from one another. The respective insulation element may therefore be configured to avoid or at least restrict transport of heat between mutually insulated neighboring battery cells. A chain reaction inside the battery device in the event of a runaway of one of the battery cells of the battery device may therefore be restricted particularly well.

According to another configuration of the invention, each battery cell rests at least at a first side on the thermally conductive potting compound or the thermally conductive pad and rests at least at a second side, different than the first side, on the insulation element. In this case, the respective battery cell rests at its side facing toward the at least one structural component on the thermally conductive potting compound, or the thermally conductive pad, and at its side facing toward a further battery cell on the insulation element. This arrangement makes it possible for transfer of heat from one battery cell to a neighboring battery cell of the battery device to be restricted by way of the insulation element arranged between the neighboring battery cells, while heat can be forwarded particularly well from the respective battery cell to the at least one structural component through the thermally conductive potting compound, or the thermally conductive pad. Heat can therefore be dissipated particularly well and rapidly from the respective battery cells through the at least one structural component, to which the respective battery cells are thermally conductively connected via the thermally conductive potting compound, or the thermally conductive pad. The at least one first side and the at least one second side of the respective battery cell may, for example, be arranged next to one another. In this way, for example, the battery cell may be thermally insulated at the top from a neighboring battery cell by way of a respective insulation element and cooled sideways by way of the thermally conductive potting compound resting on the at least one structural component, or the thermally conductive pad resting on the at least one structural component.

According to another configuration of the invention, the thermally conductive potting compound has a thermal conduction coefficient greater than or equal to 1.5 watts per square meter per kelvin. In this case, it has been found particularly advantageous for the thermally conductive potting compound to have a thermal conduction coefficient of about 10 watts per square meter per kelvin. By way of the thermally conductive potting compound, a particularly large amount of heat can therefore be transported away particularly rapidly from the respective battery cells of the battery device, in particular a runaway battery cell, to the at least one structural component resting on the thermally conductive potting compound so that the battery cells, or the runaway battery cell, can be cooled particularly well via the thermally conductive potting compound.

According to another configuration of the invention, at least one battery cell rests at opposite sides on respective thermally conductive potting compounds or thermally conductive pads, or at opposite sides on the thermally conductive potting compound and the thermally conductive pad. The respective battery cell may therefore rest at its opposite sides on respective thermally conductive potting compounds, or on respective thermally conductive pads, so that the battery cell, particularly in the event of a runaway, can be cooled particularly well via the opposite sides. Alternatively, the respective battery cell may rest at one side on the thermally conductive potting compound and at the other, opposite side on the thermally conductive pad, in which case heat can be dissipated from the battery cell through the thermally conductive pad and the thermally conductive potting compound to structural components respectively resting on the thermally conductive potting compound, or the thermally conductive pad. The respective battery cell can therefore be cooled particularly well at the opposite sides so that full runaway of the battery device due to a chain reaction can be avoided particularly well.

According to another configuration of the invention, at least two battery cells rest via respective thermally conductive potting compounds or thermally conductive pads on opposite sides of the at least one structural component. This means that the at least one structural component is arranged centrally between at least two battery cells and the at least two battery cells are respectively connected via the thermally conductive potting compound, or the thermally conductive pad, to the at least one structural component arranged between the battery cells. In this way, heat can be transported away from the battery cells centrally between the battery cells by way of the at least one structural component, so that transfer of heat between these battery cells arranged at opposite sides of the at least one structural component can be avoided or at least restricted. By way of the at least one structural component, which is enclosed at opposite sides by respective battery cells, heat can be dissipated particularly well from an interior of the battery device. In this way, the risk of a chain reaction in the event of a runaway of a battery cell of the battery device can be kept particularly low.

The invention furthermore relates to a motor vehicle having a battery device as already described in connection with the battery device. The motor vehicle is, in particular, configured to be powered with electrical energy from the battery device. The motor vehicle is, in particular, an electric vehicle or a hybrid vehicle. Advantages and advantageous developments of the battery device are to be regarded as advantages and advantageous developments of the motor vehicle, and vice versa.

Further features of the invention may be found in the claims, the figures and the description of the figures. The features and feature combinations mentioned above in the description and the features and feature combinations mentioned below in the description of the figures and/or only shown in the figures may be used not only in the combination respectively indicated but also in other combinations or separately, without departing from the scope of the invention.

### BRIEF DESCRIPTION OF THE DRAWING

FIG. 1 shows a schematic internal view of a battery device for a motor vehicle, having a plurality of battery cells arranged next to one another, which are each thermally insulated from one another by way of respective insulation elements, each of the battery cells resting via at least one thermally conductive potting compound on at least one structural component of the battery device so that heat can be dissipated from the respective battery cell to the respective structural component through the thermally conductive potting compound.

### DETAILED DESCRIPTION OF THE DRAWING

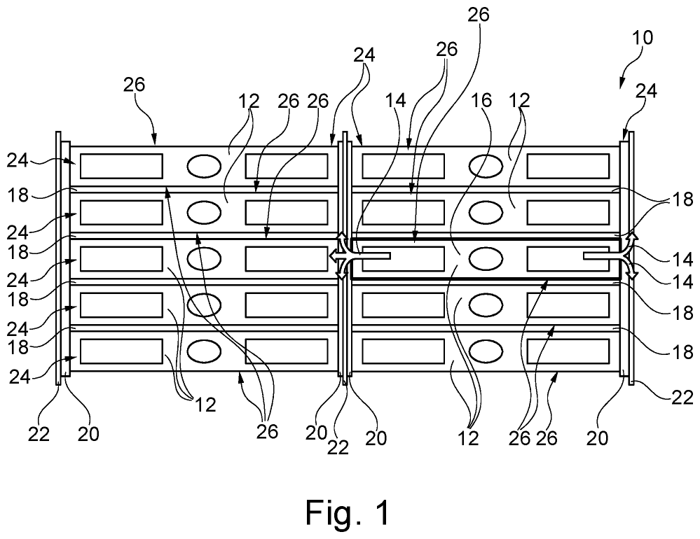

FIG. 1 shows a battery device 10 for a motor vehicle, which may in particular be a high-voltage storage unit. The battery device 10 is configured to store electrical energy and provide it for electrical powering of the motor vehicle, so that the motor vehicle can be powered with the electrical energy provided by the battery device 10. The battery device 10 comprises a plurality of battery cells 12 contained in a housing. If a so-called thermal runaway occurs in one of the battery cells 12, which is intended to mean that this battery cell runs out of control, a chain reaction may occur in which further battery cells 12 of the battery device 10 are likewise caused to run away by heat 14 from the runaway battery cell, which is denoted below with the reference 16. In particular, the respective further battery cells 12 may be caused to run away by strong heating. It is therefore necessary to avoid so much heat being transferred from the runaway battery cell 16 to further battery cells 12 that the further battery cells 12 likewise run away.

In order to keep the heat transfer from the runaway battery cell 16 to further battery cells 12 of the battery device 10 particularly low, each battery cell 12 is thermally insulated from at least one further battery cell 12, in particular from respective neighboring battery cells 12, by way of an insulation element 18. This insulation element 18 is in the present case a so-called heat shield. Each insulation element 18 is in the present case arranged between two neighboring battery cells 12 and is configured to thermally insulate the neighboring battery cells 12 from one another.

In order to allow particularly good dissipation of heat 14 from the runaway battery cell 16, the battery cells 12 respectively rest on at least one side on a thermally conductive potting compound 20, which in turn rests on at least one structural component 22. Through the thermally conductive potting compound 20, heat 14 can be dissipated particularly well and rapidly from the battery cells 12 to the resting structural component 22, so that the respective battery cells 12, in particular the runaway battery cell 16, can be cooled particularly well. In order to be able to dissipate the heat 14 from the respective battery cells 12 particularly well, the thermally conductive potting compound 20 in the present case has a thermal conductivity coefficient greater than or equal to 1.5 watts per square meter per kelvin. The thermally conductive potting compound 20 is, in particular, a plastic. In the present case, all the battery cells 12 of the battery device 10 rest via at least one thermally conductive potting compound 20 on at least one structural component 22. The at least one structural component 22 may be a housing component of the housing of the battery device 10 or a module frame of the battery device 10.

Respective lowermost battery cells 12 may rest via a thermally conductive element (not shown in FIG. 1) on a cooling device different than the structural components 22, so that the battery cells 12 can be adjusted to the operating temperature by way of the cooling device during normal operation of the battery device 10.

As may be seen in FIG. 1, the respective battery cells 12 in the present case rest at mutually opposite first sides 24 on respective thermally conductive potting compounds 20. In this case, the respective battery cells 12 may be connected via the thermally conductive potting compounds 20 to outer structural components 22 or to respective inner structural components 22 arranged between the battery cells 12. In the present case, at least one inner structural component 22 is provided in the battery device 10, and respective battery cells 12 rest on it at its opposite sides with their first sides 24 via respective thermally conductive potting compounds 20. By way of the structural component 22 which is on the inside, and therefore arranged between the respective battery cells 12, heat 14 can therefore be dissipated particularly well from an interior of the battery device 10.

As may likewise be seen from FIG. 1, the respective insulation elements 18 rest on second sides 26 of the respective battery cells 12, which are adjacent to the first sides 24. Heat transfer between respective neighboring battery cells 12 is therefore impeded inside the battery device 10, and transport of heat away from the respective battery cells 12 to the respective structural components 22 via the respective thermally conductive potting compounds 20 is promoted. A chain reaction of respective battery cells 12 in the event of a runaway of a battery cell 16 in the battery device 10 can therefore be restricted, and in particular avoided.

In the described battery device 10 it is made possible for new thermal conduction paths to be opened up in addition to the respective heat shields as heat blockers. By way of these newly created thermal conduction paths, heat 14 can be dissipated into component parts that are less critical in comparison with battery cells 12, such as the housing. By using the housing as a heat sink, a temperature in the critical runaway battery cell 16 may fall and a heat input into battery cells 12 neighboring the runaway battery cell 16 may be reduced. This combination of heat blockers from barrier cells 12 respectively neighboring the runaway battery cell 16 and heat distribution to the structural components 22, in particular the housing, may have the effect that the battery cells 12 neighboring the runaway battery cell 16 do not reach a temperature that is critical for runaway and consequently do not enter thermal runaway, and therefore do not run out of control. In this way, the chain reaction and therefore propagation in the event of the runaway battery cell 16 could be stopped.

Overall, the invention shows a way in which a thermally conductive potting compound 20 may be used for heat distribution in the case of a cell defect, in the present case a runaway of the battery cell 16.

### LIST OF REFERENCES

10 battery device
12 battery cell
14 heat
16 runaway battery cell
18 insulation element
20 thermally conductive potting compound
22 structural component
24 first side
26 second side

1.-10. (canceled)

11. A battery device for a motor vehicle, the battery device comprising:
a plurality of battery cells contained in a housing, wherein:
the plurality of battery cells rest at least on a thermally conductive potting compound or a thermally conductive pad, and
the thermally conductive potting compound or the thermally conductive pad rests on a structural component of the battery device so that heat is dissipatable from the battery cells to the structural component through the thermally conductive potting compound or the thermally conductive pad.

12. The battery device according to claim 11, wherein:
the structural component is the housing or a module frame of the battery device.

13. The battery device according to claim 11, wherein:
each battery cell of the plurality of the battery cells of the battery device rests via the thermally conductive potting compound or the thermally conductive pad on the structural component of the battery device.

14. The battery device according to claim 11, wherein:
respective lowermost battery cells of the plurality of battery cells of the battery device rest via a thermally conductive element on a cooling device different than the structural component.

15. The battery device according to claim 11, wherein:
each battery cell of the plurality of battery cells is thermally insulated from at least one other battery cell of the plurality of battery cells by an insulation element.

16. The battery device according to claim 15, wherein:
each battery cell of the plurality of battery cells rests at least at a first side on the thermally conductive potting compound or the thermally conductive pad and rests at least at a second side on the insulation element, wherein the first side is different from the second side.

17. The battery device according to claim 11, wherein:
the thermally conductive potting compound has a thermal conduction coefficient greater than or equal to 1.5 W/m²K.

18. The battery device according to claim 11, wherein:
at least one battery cell of the plurality of the battery cells rests at opposite sides on respective thermally conductive potting compounds or respective thermally conductive pads, or at opposite sides on the thermally conductive potting compound and the thermally conductive pad.

19. The battery device according to claim 11, wherein:
at least two battery cells of the plurality of battery cells rest via respective thermally conductive potting compounds or respective thermally conductive pads on opposite sides of the structural component.

20. A motor vehicle comprising the battery device according to claim 11.
